(19) United States
(12) Patent Application Publication
(10) Pub. No.: US 2008/0079351 A1
(43) Pub. Date: Apr. 3, 2008

(54) LIGHT EMITTING APPARATUS

(75) Inventors: Seiichi TOKUNAGA, Suita-shi (JP); Yasuhiko Nomura, Osaka-shi (JP)

Correspondence Address: MOTS LAW, PLLC, 1001 PENNSYLVANIA AVE. N.W., SOUTH, SUITE 600, WASHINGTON, DC, 20004, US

(73) Assignee: SANYO ELECTRIC CO., LTD., Moriguchi-shi (JP)

(21) Appl. No.: 11/862,707

(22) Filed: Sep. 27, 2007

(30) Foreign Application Priority Data
Sep. 28, 2006 (JP) JP2006-264505
Sep. 20, 2007 (JP) JP2007-244465

(51) Int. Cl. H01J 1/62

(52) U.S. Cl. 313/498

(57) ABSTRACT

A fluorescent substance containing resin fills a container in a light emitting apparatus so as to cover a light emitting device and a spacer. In a region where the power of light emitted from the light emitting device is high, the volume of the first fluorescent element containing a blue light emitting fluorescent material is large. In a region where the power of the emitted light is low, the volume of a second fluorescent element containing a green light emitting fluorescent material and a red light emitting fluorescent material is large.

### BACKGROUND OF THE INVENTION

1. Field of the Invention

The present invention relates to a light emitting apparatus that converts light emitted from a light emitting device such as a light emitting diode or a semiconductor laser device into light with a wavelength longer than the emitted light using a fluorescent substance.

2. Description of the Background Art

In recent years, light emitting apparatuses that emit white light or the like by technologies for converting light emitted from light emitting diodes (LEDs) into light beams with respectively different wavelengths using color conversion materials such as fluorescent substances have been developed.

In the future, light emitting apparatuses of this type have been expected to be utilized as light sources for illumination, so that improvements in color rendering properties and improvements in luminous efficiencies are required.

Conventionally, in the light emitting apparatuses that emit white light, methods of irradiating light from blue LEDs onto yellow and red fluorescent substances to obtain pseudo-white light have been used. In recent years, methods of obtaining white light by combining ultraviolet LEDs and three types of fluorescent materials in blue, green, and red have been attempted in order to further improve the color rendering properties.

On the other hand, as methods of improving the luminous efficiencies, JP 2005-276883 A, for example, discloses a method of arranging a fluorescent substance in large amounts in a portion where the power of light emitted from an LED is high, to improve the luminous efficiency of a light emitting apparatus.

The fluorescent material used for the fluorescent substance in the above-mentioned light emitting apparatus is generally excited to convert light with a short wavelength into light with a long wavelength and emit the long-wavelength light. In a light emitting apparatus in which a fluorescent substance has a first fluorescent material that is excited to emit a light beam with a first wavelength and a second fluorescent material that is excited to emit a light beam with a second wavelength longer than the first wavelength, even if the long-wavelength light emitted by exciting the second fluorescent material is incident on the first fluorescent material, the first fluorescent material is not excited to emit light.

### SUMMARY OF THE INVENTION

According to an aspect of the present invention, a light emitting apparatus includes a light emitting device, and a fluorescent substance that converts light emitted from the light emitting device into light with a longer wavelength than the emitted light, wherein the fluorescent substance has first and second regions, and contains a first fluorescent material that is excited to emit a light beam with a first wavelength, and a second fluorescent material that is excited to emit a light beam with a second wavelength longer than the first wavelength, the power of the emitted light in a first direction is higher than the power of the emitted light in a second direction, the volume of the first region in the first direction is larger than the volume of the second region in the first direction, and the volume of the second region in the second direction is larger than the volume of the first region in the second direction, and the ratio of the concentration of the first fluorescent material to the concentration of the second fluorescent material in the first region is higher than the ratio of the concentration of the first fluorescent material to the concentration of the second fluorescent material in the second region.

In the light emitting apparatus, the emitted light from the light emitting device is incident on the fluorescent substance having the first and second regions. The power of the emitted light in the first direction is higher than the power of the emitted light in the second direction. The volume of the first region in the first direction is larger than the volume of the second region in the first direction, and the volume of the second region in the second direction is larger than the volume of the first region in the second direction. Further, the ratio of the concentration of the first fluorescent material to the concentration of the second fluorescent material in the first region is higher than the ratio of the concentration of the first fluorescent material to the concentration of the second fluorescent material in the second region.

By such a configuration, in the regions in the first direction, the first fluorescent material that is excited to emit the light beam with a shorter first wavelength is arranged in larger amounts than the second fluorescent material. This causes much of the light emitted from the light emitting device to be converted into the light beam with the first wavelength by the first fluorescent material.

Furthermore, in the regions in the second direction, the second fluorescent material that is excited to emit the light with a longer second wavelength is arranged in larger amounts than the first fluorescent material. This causes some of the light emitted from the light emitting device to be converted into the light beam with the second wavelength and causes the light beam with the first wavelength emitted by exciting the first fluorescent material to be converted into the light beam with the second wavelength. That is, the light beam with the first wavelength can contribute to the light emission by the excitation of the second fluorescent material.

Thus, in the light emitting apparatus, much of the light emitted from the light emitting device is converted into the light beam with the first wavelength that can contribute to the light emission by the excitation of the second fluorescent material. This causes the utilization efficiency of the fluorescent material that contributes to the light emission by the excitation to rise. Consequently, the light emitted from the light emitting device can be converted into the light beam with a longer wavelength at high efficiency. As a result, the luminous efficiency of the light emitting apparatus is improved while allowing high luminance light emission.

The first fluorescent material may include a fluorescent material that is excited to emit a blue-based light beam.

In this case, in the regions in the first direction in which the power of the light emitted from the light emitting device is high, the fluorescent material that is excited to emit the blue-based light beam is arranged in large amounts. This causes much of the light emitted from the light emitting device to be converted into the blue-based light beam. Since the blue-based light beam has a short wavelength in a visible light region, many types of fluorescent materials from a fluorescent material that is excited to emit a green-based light beam to a fluorescent material that is excited to emit a red-based light beam can be utilized as the second fluorescent material.

The first fluorescent material may include a fluorescent material that is excited to emit a blue-based light beam, and the second fluorescent material may include a fluorescent material that is excited to emit a green-based light beam and a fluorescent material that is excited to emit a red-based light beam.

In this case, in the regions in the first direction in which the power of the light emitted from the light emitting device is high, the first fluorescent material that is excited to emit the blue-based light beam is arranged in large amounts. This causes much of the light emitted from the light emitting device to be converted into the blue-based light beam. Furthermore, the blue-based light beam obtained by the conversion is incident on the second fluorescent material, which is excited to emit the green-based light beam and the red-based light beam. Consequently, white light can be emitted by synthesizing the light beams in the three primary colors such as the blue-based, green-based, and red-based light beams.

A region containing no fluorescent material may be provided between the light emitting device and the fluorescent substance.

In this case, the light emission by the excitation of the fluorescent material is inhibited in a region where the luminous intensity of the light emitted from the light emitting device is unstable in proximity to the light emitting device.

The first region may be composed of a first sheet containing the first fluorescent material, and the second region may be composed of a second sheet containing the second fluorescent material.

In this case, the luminescent color can be adjusted by adjusting the number of first and second sheets or the thicknesses thereof, for example. The first and second sheets can be removably attached by mounting the first and second sheets without fixing the sheets, so that the luminescent color can be more easily adjusted.

Note that the blue-based light beam is a light beam with a peak wavelength of approximately 410 to 500 nm in an emission spectrum, the green-based light beam is a light beam with a peak wavelength of approximately 500 to 570 nm in the emission spectrum, and the red-based light beam is a light beam with a peak wavelength of approximately 570 to 660 nm in the emission spectrum.

The emitted light may be ultraviolet light. The first and second regions may be concentrically arranged. The light emitting device may be a light emitting diode. The light emitting device may be a semiconductor laser device.

The light emitting apparatus may further include a support that supports the fluorescent substance such that the emitted light from the light emitting device is incident on the fluorescent substance.

Other features, elements, characteristics, and advantages of the present invention will become more apparent from the following description of preferred embodiments of the present invention with reference to the attached drawings.

### BRIEF DESCRIPTION OF THE DRAWINGS

FIG. 1 is a schematic cross-sectional view showing the overall configuration of a light emitting apparatus according to a first embodiment of the present invention;

FIG. 2 is a schematic cross-sectional view showing the configuration of a principal part of the light emitting apparatus according to the first embodiment of the present invention;

FIG. 3 is a diagram showing the results of measurement of the power of light emitted from a light emitting device used for the first embodiment of the present invention;

FIG. 4 is a schematic cross-sectional view showing the arrangement of fluorescent materials used for the light emitting apparatus according to the first embodiment of the present invention;

FIG. 5 is a diagram showing emission spectrums of light beams respectively emitted by exciting fluorescent materials used for the light emitting apparatus according to the first embodiment of the present invention;

FIG. 6 is a schematic cross-sectional view showing the overall configuration of a light emitting apparatus according to a second embodiment of the present invention;

FIG. 7 is a schematic cross-sectional view showing the configuration of a principal part of the light emitting apparatus according to the second embodiment of the present invention;

FIG. 8 is a diagram showing the results of measurement of the power of light emitted from a light emitting device used for the second embodiment of the present invention;

FIG. 9 is a schematic cross-sectional view showing the arrangement of fluorescent materials used for the light emitting apparatus according to the second embodiment of the present invention;

FIG. 10 is a schematic cross-sectional view showing the arrangement of fluorescent materials used for a light emitting apparatus according to a third embodiment of the present invention;

FIG. 11 is a schematic cross-sectional view showing the arrangement of fluorescent materials used for a light emitting apparatus according to a fourth embodiment of the present invention;

FIG. 12 is a schematic cross-sectional view showing the overall configuration of a light emitting apparatus according to a fifth embodiment of the present invention;

FIG. 13 is a diagram showing the results of measurement of the power of light at an emission facet of a light diffuser and the arrangement of a fluorescent substance containing resin in the fifth embodiment of the present invention;

FIG. 14 is a schematic side view showing another example of the light diffuser;

FIG. 15 is a schematic side view showing still another example of the light diffuser;

FIG. 16 is a schematic side view showing a further example of the light diffuser;

FIG. 17 is a schematic cross-sectional view showing another example of the arrangement of a first fluorescent element in a fluorescent substance containing resin; and

FIG. 18 is a diagram showing another example of the power of light at an emission facet of a light diffuser and the arrangement of a fluorescent substance containing resin.

### DESCRIPTION OF THE PREFERRED EMBODIMENTS

Preferred embodiments of the present invention will be described on the basis of the drawings.

### (1) First Embodiment

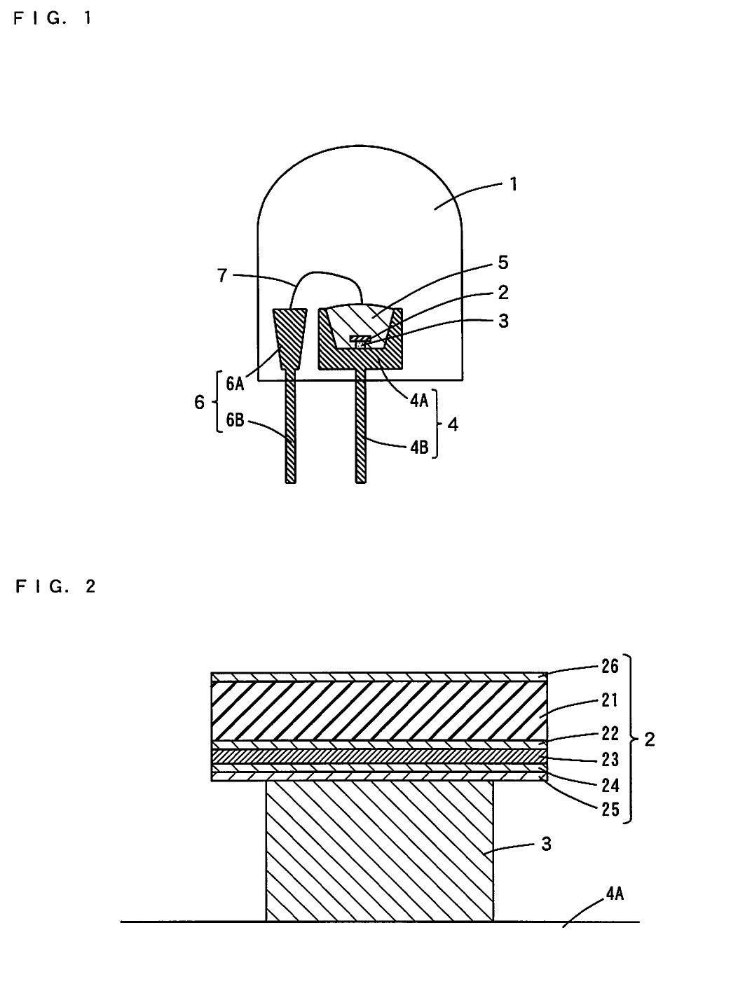

FIG. 1 is a cross-sectional view schematically showing the configuration of a light emitting apparatus according to a first embodiment of the present invention.

In the light emitting apparatus according to the first embodiment, a light emitting device 2 is arranged inside a sealing resin 1. Ap-side electrode of the light emitting device 2 is electrically connected to a frame 4 with a spacer 3 composed of Cu (copper) sandwiched therebetween. The frame 4 is composed of a conductive material, and includes a concavely-curved container 4A containing the light emitting device 2 and the spacer 3 in the sealing resin 1 and a terminal 4B extending out of the sealing resin 1 from the bottom of the container 4A. A fluorescent substance containing resin 5 fills the container 4A so as to cover the light emitting device 2 and the spacer 3.

An n-side electrode of the light emitting device 2 is connected to a frame 6 through a wire 7 extending out of the fluorescent substance containing resin 5. The frame 6 is composed of a conductive material, and includes a connector 6A connected to the wire 7 within the sealing resin 1 and a terminal 6B extending out of the sealing resin 1 from the bottom of the connector 6A.

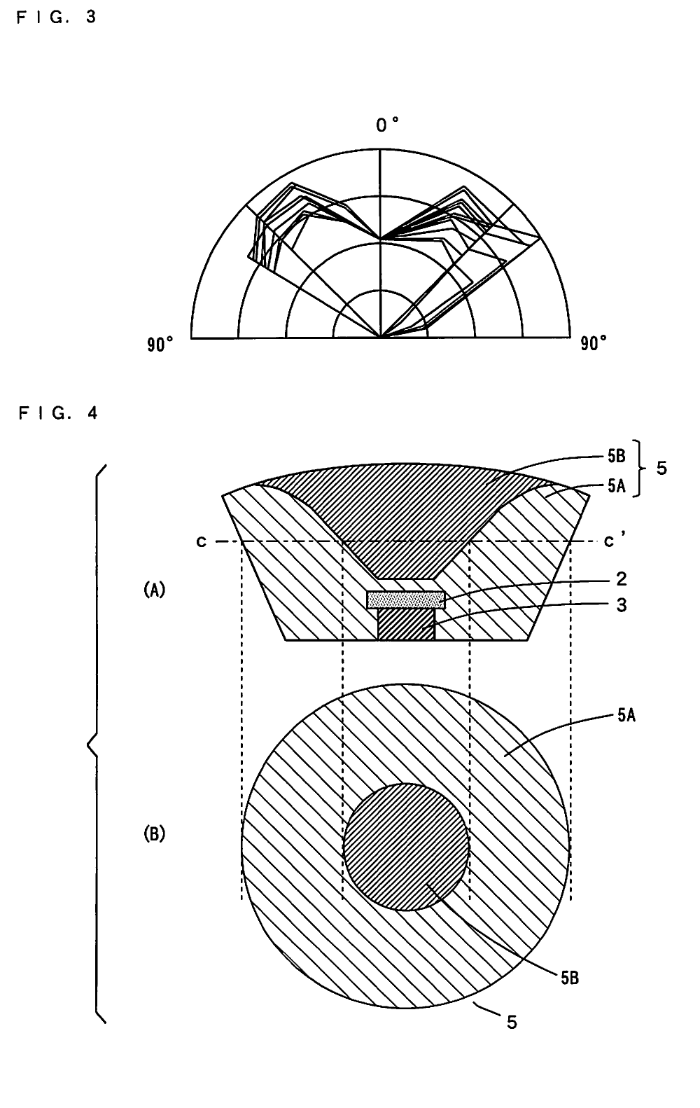

FIG. 2 is a diagram showing the schematic configuration of the light emitting device 2 and a state where the light emitting device 2 is mounted on the spacer 3.

The light emitting device 2 is a light emitting diode composed of a gallium nitride-based semiconductor material and emitting ultraviolet light with a wavelength of about 400 nm. An n-side layer 22 such as an n-type cladding layer, a light emitting layer 23, and a p-side layer 24 such as a p-type cladding layer are formed in this order on a substrate 21 composed of GaN (gallium nitride). A p-side electrode 25 is formed on the p-side layer 24 in the light emitting device 2, and an n-side electrode 26 is formed on a surface, on the opposite side of a surface on which the layers are formed, of the substrate 21.

In the light emitting device 2, the p-side electrode 25 is arranged to face the spacer 3, and is connected to the spacer 3 with a solder (not shown). In this arrangement, the thick substrate 21 is farther away from the spacer 3 than the light emitting layer 23. In the whole light emitting device 2, therefore, the light emitting layer 23 is positioned nearer the spacer 3. A surface, facing the spacer 3, of the light emitting device 2 is greater than a surface, facing the light emitting device 2, of the spacer 3. Thus, the periphery of the surface, facing the spacer 3, of the light emitting device 2 does not face the spacer 3.

In order to examine a state where the ultraviolet light from the light emitting device 2 in the first embodiment is emitted, the light emitting device 2 and the spacer 3 are mounted on a measuring device, to examine an orientation distribution of the luminous intensity of the emitted light by far field measurement. Specifically, a light receiving sensor is moved so as to draw a semicircular trajectory at positions equally spaced 10 cm apart from the light emitting device 2, to measure the luminous intensity.

FIG. 3 is a diagram showing the results of measurement at 15 degrees spacing of the power of the light emitted from the light emitting device 2 in the first embodiment by the above-mentioned far field measurement. Letting zero degree be a direction perpendicular to a surface on which the light emitting device 2 is mounted (a surface on which the light emitting device 2 and the spacer 3 face each other) and letting 90 degrees be a direction parallel to the surface on which the light emitting device 2 is mounted, the intensity of the light is relatively displayed on the basis of the maximum value of measured values.

Measurement in one cycle is made by moving the light receiving sensor in a semicircular shape from a position at 90 degrees on one side to a position at 90 degrees on the opposite side via a position at zero degree. Measurement in a total of 12 cycles is made while moving the light receiving sensor 15 degrees at a time along the surface on which the light emitting device 2 is mounted, that is, measurement is made on the entire circumference on the light emission side of the light emitting device 2. A plurality of lines shown in FIG. 3 indicate the results of the measurement in a total of 12 cycles.

As can be seen from the results of the measurement shown in FIG. 3, the luminous intensity of the light emitted from the light emitting device 2 in a direction inclined at approximately 30 degrees to 60 degrees from the direction perpendicular to the surface on which the light emitting device 2 is mounted is higher, as compared with that in the direction perpendicular to the mounting surface and its surrounding directions on the entire circumference on the light emission side of the light emitting device 2.

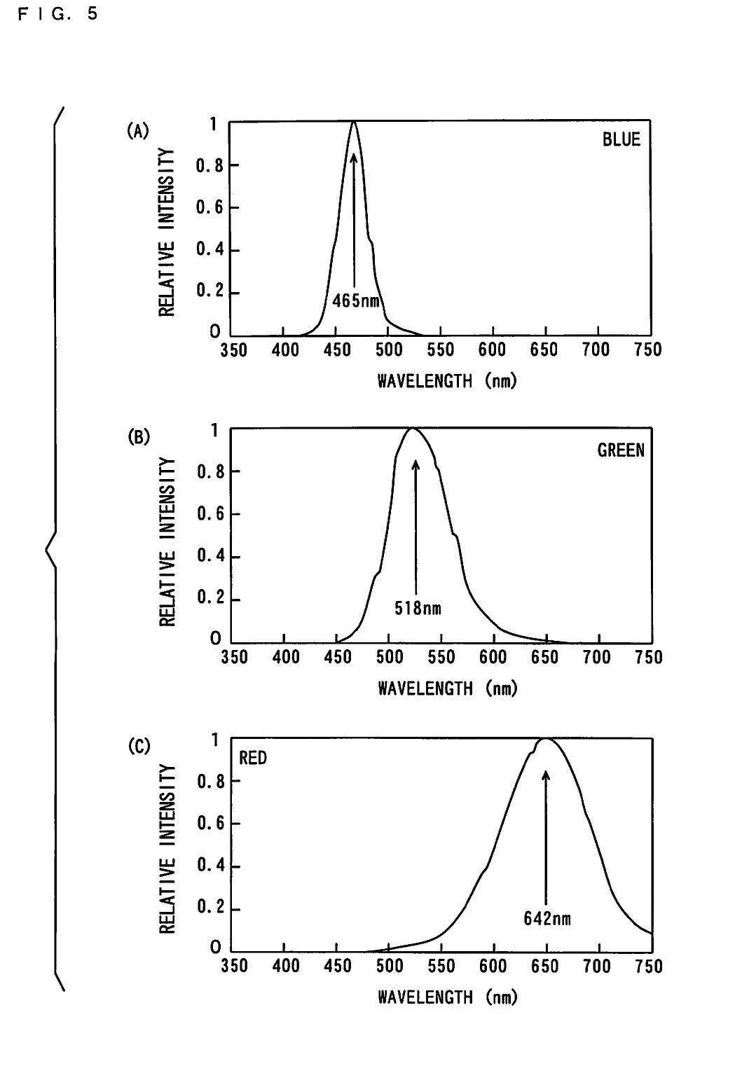

FIG. 4 is a diagram showing a state where the container 4A in the light emitting apparatus according to the first embodiment is filled with the fluorescent substance containing resin 5, where FIG. 4(A) is a longitudinal sectional view, and FIG. 4(B) is a transverse sectional view taken along a one-dot and dash line c-c′ of FIG. 4(A).

In the first embodiment of the present invention, the fluorescent substance containing resin 5 that fills the container 4A includes a first fluorescent element 5A and a second fluorescent element 5B. The first fluorescent element 5A contains a blue light emitting fluorescent material (first fluorescent material) composed of a Eu (europium) containing oxide. The second fluorescent element 5B contains a green light emitting fluorescent material (second fluorescent material) composed of a Cu containing sulfide and a red light emitting fluorescent material (second fluorescent material) composed of a sulfate oxide.

FIG. 5 is a diagram showing emission spectrums of light beams respectively emitted by exciting the fluorescent materials used in the present embodiment, where FIG. 5(A) illustrates the emission spectrum of the light beam emitted by exciting the blue light emitting fluorescent material, FIG. 5(B) illustrates the emission spectrum of the light beam emitted by exciting the green light emitting fluorescent material, and FIG. 5(C) illustrates the emission spectrum of the light beam emitted by exciting the red light emitting fluorescent material. In FIG. 5, the vertical axis indicates the relative intensity of light, and the horizontal axis indicates the wavelength thereof.

In the first embodiment of the present invention, the blue light emitting fluorescent material in the first fluorescent element 5A is excited to emit a blue light beam with a peak wavelength of 465 nm, as shown in FIG. 5(A). The green light emitting fluorescent material in the second fluorescent element 5B is excited to emit a green light beam with a peak wavelength of 518 nm, as shown in FIG. 5(B), and the red light emitting fluorescent material in the second fluorescent element 5B is excited to emit a red light beam with a peak wavelength of 642 nm, as shown in FIG. 5(C). That is, the fluorescent material contained in the second fluorescent element 5B is excited to emit a light beam with a longer wavelength than the fluorescent material contained in the first fluorescent element 5A.

Furthermore, the blue light emitting fluorescent material in the first fluorescent element 5A is excited by the ultraviolet light from the light emitting device 2 to emit a blue light beam, and the green light emitting fluorescent material and the red light emitting fluorescent material in the second fluorescent element 5B are excited by the blue light beam emitted by exciting the first fluorescent element 5A and the ultraviolet light from the light emitting device 2 to respectively emit a green light beam and a red light beam.

In the light emitting apparatus according to the first embodiment, the first fluorescent element 5A fills a lower portion of the container 4A so as to completely cover the light emitting device 2 and the spacer 3 and so as to be thick throughout the periphery of the container 4A, while being thin at the center of the container 4A above the light emitting device 2, as shown in FIG. 4. The second fluorescent element 5B fills the container 4A so as to cover the top of the first fluorescent element 5A.

Thus, the second fluorescent element 5B is thin throughout the periphery of the container 4A thickly filled with the first fluorescent element 5A, while being thick at the center of the container 4A thinly filled with the first fluorescent element 5A.

In such a configuration, in a region where the luminous intensity of the light emitted from the light emitting device 2 is high, that is, a region in the direction inclined at approximately 30 degrees to 60 degrees from the direction perpendicular to the surface on which the light emitting device 2 is mounted, the first fluorescent element 5A and the second fluorescent element 5B are respectively formed in large amounts and small amounts over the entire circumference thereof. On the other hand, in a region where the luminous intensity of the light emitted from the light emitting device 2 is low, that is, a region in the direction perpendicular to the surface on which the light emitting device 2 is mounted and its surrounding directions (a region in a direction inclined at zero degree to 30 degrees from the direction perpendicular to the mounting surface), the first fluorescent element 5A and the second fluorescent element 5B are respectively formed in small amounts and large amounts. Further, in the region where the luminous intensity of the light emitted from the light emitting device 2 is high, the second fluorescent element 5B is not arranged between the light emitting device 2 and the first fluorescent element 5A.

In the present embodiment, the container 4A is filled with the fluorescent substance containing resin 5 in the following manner.

The blue light emitting fluorescent material is mixed into the silicon resin at a ratio of 12% by weight, and is sufficiently diffused, to produce a first fluorescent material containing resin. A mixture of the green light emitting fluorescent material and the red light emitting fluorescent material (e.g., a mixture ratio of 2:5 in weight) is mixed into the silicon resin at a ratio of 28% by weight, and is diffused, to produce a second fluorescent material containing resin.

First, the spacer 3 and the light emitting device 2 are mounted in the container 4A, and the wire 7 is connected to the light emitting device 2. Then, the first fluorescent material containing resin is applied to the inside of the container 4A so as to have a thickness similar to that of the first fluorescent element 5A shown in FIG. 4, followed by heating for one hour at a temperature of 150° C., to cure the resin.

Then, the second fluorescent material containing resin is applied to the inside of the container 4A so as to have a thickness similar to that of the second fluorescent element 5B shown in FIG. 4, followed by heating for one hour at a temperature of 150° C., to cure the resin.

Thus, the container 4A is filled with the first fluorescent element 5A and the second fluorescent element 5B in the above-mentioned thickness distribution.

In this case, the concentration of the second fluorescent material in the first fluorescent element 5A is zero, and the concentration of the first fluorescent material in the second fluorescent element 5B is zero.

In the light emitting apparatus according to the first embodiment of the present invention, the ultraviolet light emitted from the light emitting device 2 toward the region where the luminous intensity thereof is high, that is, the region in the direction inclined at approximately 30 degrees to 60 degrees from the direction perpendicular to the surface on which the light emitting device 2 is mounted is incident on the first fluorescent element 5A. Thus, the blue light beam is emitted by exciting the first fluorescent element 5A. At this time, the fluorescent materials that are excited to emit the light beams with the other wavelengths, for example, the green light beam and the red light beam are not mixed with the first fluorescent element 5A. Therefore, the ultraviolet light emitted from the light emitting device 2 toward the region where the luminous intensity thereof is high is efficiently wavelength-converted into the blue light beam in the first fluorescent element 5A.

On the other hand, the ultraviolet light emitted from the light emitting device 2 toward the region where the luminous intensity thereof is low is incident on the second fluorescent element 5B. Therefore, the ultraviolet light emitted from the light emitting device 2 is hardly incident on the second fluorescent element 5B, while the blue light beam emitted by exciting the first fluorescent element 5A is incident thereon. Thus, the green light beam and the red light beam are emitted by exciting the second fluorescent element 5B.

That is, in the light emitting apparatus according to the first embodiment, much of the light emitted from the light emitting device 2 is efficiently wavelength-converted into the blue light beam in the first fluorescent element 5A, and some of the blue light beam obtained by the wavelength-conversion is efficiently wavelength-converted into the green light beam and the red light beam in the second fluorescent element 5B, to emit white light outward.

Here, the luminescent properties of the light emitting apparatus according to the first embodiment were measured. The emitted white light had an average color rendering index Ra of 68 and a color temperature in the range of 10000K. The flux of the white light was 1.11 (1 m), and the luminous efficiency of the light emitting apparatus was 16.5 (1 m/W).

Then, a light emitting apparatus B was manufactured, to conduct a comparative experiment. In the light emitting apparatus B, the fluorescent substance containing resin 5 in the light emitting apparatus according to the first embodiment of the present invention was replaced with a fluorescent substance containing resin containing three types of fluorescent materials. The fluorescent substance containing resin containing the three types of fluorescent materials was obtained by uniformly mixing the three types of fluorescent materials used in the first embodiment.

The mixture ratio in weight of the fluorescent materials, i.e., the blue light emitting fluorescent material, the green light emitting fluorescent material, and the red light emitting fluorescent material in the light emitting apparatus B was 3:2:5, and the concentration of an entire fluorescent substance in a silicon resin was 20% by weight. Further, after confirming that the light emitting apparatus B emitted white light having an average color rendering index Ra of 69 and a color temperature in the range of 9000K, similarly to the light emitting apparatus according to the first embodiment, the flux of the white light and the luminous efficiency of the light emitting apparatus were compared with those in the first embodiment.

As a result, in the light emitting apparatus B, the light flux was 1.04 (1 m), and the luminous efficiency was 15.7 (1 m/W). In the light emitting apparatus according to the first embodiment, the light flux and the luminous efficiency thus respectively took values higher than those in the light emitting apparatus B. Therefore, it could be confirmed that the luminous efficiency in the first embodiment of the present invention was improved.

### (2) Modification of First Embodiment

In a modification, a light emitting apparatus having a first fluorescent element 5A and a second fluorescent element 5B is manufactured using a light emitting device 2 and a fluorescent substance that are the same as those in the first embodiment. The light emitting apparatus in the modification also emits white light.

The light emitting apparatus in the modification differs from the light emitting apparatus according to the first embodiment in the types, the amounts, and the mixture ratio of fluorescent materials contained in each of the first fluorescent element 5A and the second fluorescent element 5B of the fluorescent substance.

A container 4A in the modification is filled with a fluorescent substance containing resin S in the following manner.

A mixture of a blue light emitting fluorescent material, a green light emitting fluorescent material, and a red light emitting fluorescent material (a mixture ratio in weight of 15:2:5, for example) is mixed into a silicon resin at a ratio of 21% by weight, and is diffused, to produce a first mixed resin. Further, a mixture of a blue light emitting fluorescent material, a green light emitting fluorescent material, and a red light emitting fluorescent material (a mixture ratio in weight of 3:10:50, for example) is mixed into a silicon resin at a ratio of 7% by weight, and is diffused, to produce a second mixed resin. Here, the blue light emitting fluorescent material is a first fluorescent material, and the green light emitting fluorescent material and the red light emitting fluorescent material are second fluorescent materials.

Then, the first mixed resin is applied to the inside of the container 4A so as to have a thickness similar to that of the first fluorescent element 5A shown in FIG. 4, followed by heating for one hour at a temperature of 150° C., to cure the resin. Further, the second mixed resin is applied to the inside of the container 4A so as to have a thickness similar to that of the second fluorescent element 5B shown in FIG. 4, followed by heating for one hour at a temperature of 150° C., to cure the resin.

Thus, the container 4A is filled with the first fluorescent element 5A and the second fluorescent element 5B in the same thickness distribution as that in the first embodiment.

The average color rendering index and the color temperature of the light emitting apparatus in the modification are the same as those in the light emitting apparatus according to the first embodiment, and the flux of emitted light is lower than that in the light emitting apparatus according to the first embodiment, while being higher than that in a light emitting apparatus in a comparative experiment.

Thus, the flux of emitted light becomes higher, as compared with that in a case where the three types of fluorescent materials are uniformly mixed, by making the ratio of the concentration of the first fluorescent material to the concentration of the second fluorescent material in the first fluorescent element 5A higher than the ratio of the concentration of the first fluorescent material to the concentration of the second fluorescent material in the second fluorescent element 5B.

### (3) Second Embodiment

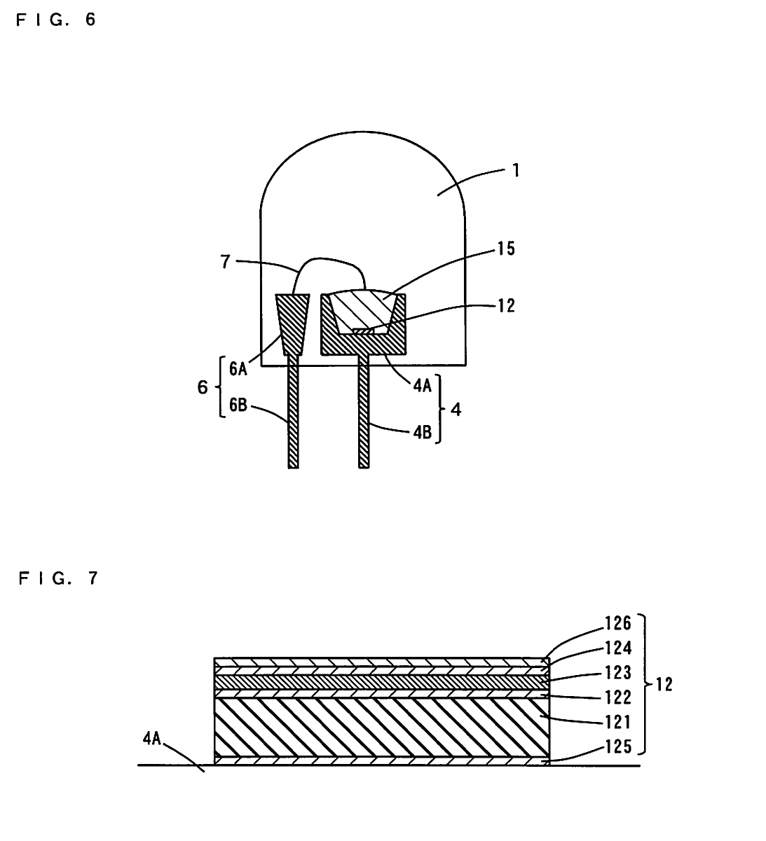

FIG. 6 is a cross-sectional view schematically showing the configuration of a light emitting apparatus according to a second embodiment of the present invention, where the same parts as those in the first embodiment are respectively assigned the same reference numerals.

In the light emitting apparatus according to the second embodiment, a light emitting device 12 is arranged inside a sealing resin 1. Ap-side electrode of the light emitting device 12 is electrically connected to a frame 4. The frame 4 includes a concavely-curved container 4A containing the light emitting device 12 in the sealing resin 1 and a terminal 4B extending out of the sealing resin 1 from the bottom of the container 4A. A fluorescent substance containing resin 15 fills the container 4A so as to cover the light emitting device 12.

An n-side electrode of the light emitting device 12 is connected to a frame 6 through a wire 7 extending out of the fluorescent substance containing resin 15. The frame 6 includes a connector 6A connected to the wire 7 within the sealing resin 1 and a terminal 6B extending out of the sealing resin 1 from the bottom of the connector 6A.

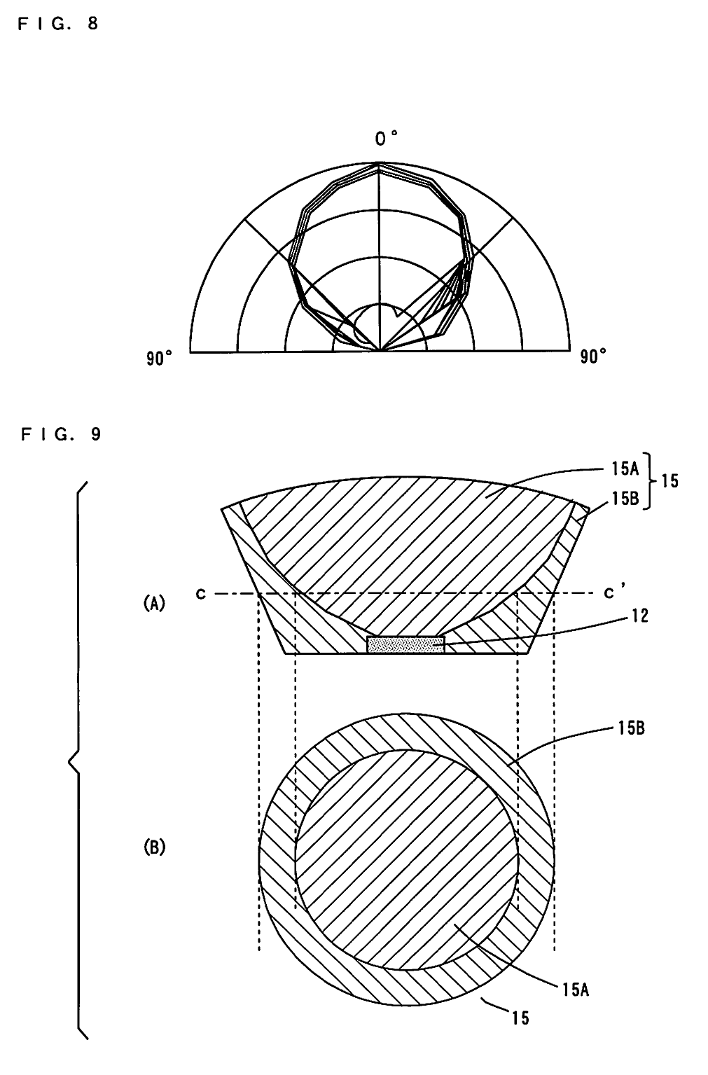

FIG. 7 is a diagram showing the schematic configuration of the light emitting device 12 and a state where the light emitting device 12 is mounted in the container 4A.

The light emitting device 12 is a light emitting diode composed of a gallium nitride-based semiconductor material and emits ultraviolet light with a wavelength of about 400 nm. A semiconductor layer including a p-side layer 122 such as a p-type cladding layer, a light emitting layer 123, and an n-side layer 124 such as an n-type cladding layer in this order is joined to a substrate 121 composed of Ge (germanium). Further, a p-side electrode 125 is formed on a surface, on the opposite side of a junction surface of the semiconductor layer, of the substrate 121, and an n-side electrode 126 is formed on a surface, on the opposite side of the substrate 121, of the n-side layer 124. The semiconductor layer joined to the substrate 121 is formed by making the n-side layer 124, the light emitting layer 123, and the p-side layer grow in this order on a GaN substrate. The GaN substrate is stripped after the semiconductor layer is joined to the substrate 121.

The light emitting device 12 is connected to the container 4A with a solder (not shown) sandwiched therebetween with the p-side electrode 125 facing a bottom surface of the container 4A. In this arrangement, the light emitting layer 123 is farther away from the bottom surface of the container 4A than the thick substrate 121. Therefore, the light emitting layer 123 is positioned farther away from the bottom surface of the container 4A in the whole light emitting device 12.

FIG. 8 is a diagram showing the results of measurement at 15 degrees spacing of the power of the light emitted from the light emitting device 12 in the second embodiment by the same method as the far field measurement described in the first embodiment.

As can be seen from the results of the measurement shown in FIG. 8, the luminous intensity of the light emitted from the light emitting device 12 in a direction perpendicular to a surface on which the light emitting device 12 is mounted and its surrounding directions (a direction inclined at zero degree to 45 degrees from the direction perpendicular to the mounting surface) is higher, as compared with that in a direction inclined at not less than 45 degrees from the direction perpendicular to the mounting surface.

FIG. 9 is a diagram showing a state where the container 4A in the light emitting apparatus according to the second embodiment is filled with the fluorescent substance containing resin 15, where FIG. 9(A) is a longitudinal sectional view, and FIG. 9(B) is a transverse sectional view taken along a one-dot and dash line c-c′ of FIG. 9(A).

In the second embodiment of the present invention, the fluorescent substance containing resin 15 that fills the container 4A includes a first fluorescent element 15A and a second fluorescent element 15B. The first fluorescent element 15A contains a blue light emitting fluorescent material (first fluorescent material) composed of a Eu containing oxide. The second fluorescent element 15B contains a green light emitting fluorescent material (second fluorescent material) composed of a Cu containing sulfide and a red light emitting fluorescent material (second fluorescent material) composed of a sulfate oxide.

The light emitting fluorescent materials in the respective colors used for the first fluorescent element 15A and the second fluorescent element 15B are the same as the fluorescent materials used in the first embodiment, and emission spectrums of light beams respectively emitted by exciting the fluorescent materials are as shown in FIG. 5. That is, the fluorescent material contained in the second fluorescent element 15B is excited to emit a light beam with a longer wavelength than the fluorescent material contained in the first fluorescent element 15A.

Furthermore, the blue light emitting fluorescent material in the first fluorescent element 15A is excited by the ultraviolet light from the light emitting device 12 to emit a blue light beam, and the green light emitting fluorescent material and the red light emitting fluorescent material in the second fluorescent element 15B are excited by the blue light beam emitted by exciting the first fluorescent element 15A to respectively emit a green light beam and a red light beam.

In the light emitting apparatus according to the second embodiment, the second fluorescent element 15B fills a lower portion of the container 4A so as to cover the light emitting device 12, excluding the center on a surface of the n-side electrode 126 in the light emitting device 12, as shown in FIG. 9. The first fluorescent element 15A fills the container 4A so as to cover the center of the n-side electrode 126 in the light emitting device 12 and the top of the second fluorescent element 15B.

In such a configuration, in a region where the luminous intensity of the light emitted from the light emitting device 12 is high, that is, a region in the direction perpendicular to the surface on which the light emitting device 12 is mounted and its surrounding directions, the first fluorescent element 15A is formed in large amounts. On the other hand, in a region where the luminous intensity of the light emitted from the light emitting device 12 is low, that is, a region in the direction inclined at not less than 45 degrees to the direction perpendicular to the surface on which the light emitting device 12 is mounted, the second fluorescent element 15B is formed in large amounts over the entire circumference thereof. Further, in the region where the luminous intensity of the light emitted from the light emitting device 12 is high, the second fluorescent element 15B is not arranged between the light emitting device 12 and the first fluorescent element 15A.

In the present embodiment, the container 4A is filled with the fluorescent substance containing resin 15 in the following manner.

The blue light emitting fluorescent material is mixed into a silicon resin at a ratio of 12% by weight, and is sufficiently diffused, to produce a first fluorescent material containing resin. A mixture of the green light emitting fluorescent material and the red light emitting fluorescent material (e.g., a mixture ratio of 2:5 in weight) is mixed into the silicon resin at a ratio of 28% by weight, and is diffused, to produce a second fluorescent material containing resin.

First, the light emitting device 12 is mounted in the container 4A, and the wire 7 is connected to the light emitting device 12. Then, the second fluorescent material containing resin is applied to the inside of the container 4A so as to have a thickness similar to that of the second fluorescent element 15B shown in FIG. 9, followed by heating for one hour at a temperature of 150° C., to cure the resin.

Then, the first fluorescent material containing resin is applied to the inside of the container 4A so as to have a thickness similar to that of the first fluorescent element 15A shown in FIG. 9, followed by heating for one hour at a temperature of 150° C., to cure the resin.

Thus, the container 4A is filled with the first fluorescent element 15A and the second fluorescent element 15B in the above-mentioned thickness distribution.

In the light emitting apparatus according to the second embodiment of the present invention, the ultraviolet light emitted from the light emitting device 12 toward the region where the luminous intensity thereof is high, that is, the region in the direction perpendicular to the surface on which the light emitting device 12 is mounted and its surrounding directions is incident on the first fluorescent element 15A. Thus, the blue light beam is emitted by exciting the first fluorescent element 15A. At this time, the fluorescent materials that are excited to emit the light beams with the other wavelengths, for example, the green light beam and the red light beam are not mixed with the first fluorescent element 15A. Therefore, the ultraviolet light emitted from the light emitting device 12 toward the region where the luminous intensity thereof is high is efficiently wavelength-converted into the blue light beam in the first fluorescent element 15A.

The second fluorescent element 15B is arranged in the region where the luminous intensity of the ultraviolet light emitted from the light emitting device 12 is low. Therefore, the ultraviolet light emitted from the light emitting device 12 is hardly incident on the second fluorescent element 15B, while the blue light beam emitted by exciting the first fluorescent element 15A is incident thereon. Thus, the green light beam and the red light beam are emitted by exciting the second fluorescent element 15B.

That is, in the light emitting apparatus according to the second embodiment, much of the light emitted from the light emitting device 12 is efficiently wavelength-converted into the blue light beam in the first fluorescent element 15A, and some of the blue light beam obtained by the wavelength-conversion is efficiently wavelength-converted into the green light beam and the red light beam in the second fluorescent element 15B, to emit white light outward.

Here, the luminescent properties of the light emitting apparatus according to the second embodiment were measured. The emitted white light had an average color rendering index Ra of 83 and a color temperature in the range of 8000K. The flux of the white light was 1.06 (1 m), and the luminous efficiency of the light emitting apparatus was 14.5 (1 m/W).

Then, a light emitting apparatus C was manufactured, to conduct a comparative experiment. In the light emitting apparatus C, the fluorescent substance containing resin 15 in the light emitting apparatus according to the second embodiment of the present invention was replaced with a fluorescent substance containing resin containing three types of fluorescent materials. The fluorescent substance containing resin containing the three types of fluorescent materials was obtained by uniformly mixing the three types of fluorescent materials used in the second embodiment.

The mixture ratio in weight of the fluorescent materials, i.e., the blue light emitting fluorescent material, the green light emitting fluorescent material, and the red light emitting fluorescent material in the light emitting apparatus C was 3:2:5, and the total weight ratio of a fluorescent substance in a silicon resin was 20%. Further, after confirming that the light emitting apparatus C emitted white light having an average color rendering index Ra of 82 and a color temperature in the range of 9000K, similarly to the light emitting apparatus according to the second embodiment, the flux of the white light and the luminous efficiency of the light emitting apparatus were compared with those in the second embodiment.

As a result, in the light emitting apparatus C, the light flux was 0.88 (1 m), and the luminous efficiency was 12.0 (1 m/W). Thus, in the light emitting apparatus according to the second embodiment, the light flux and the luminous efficiency respectively took values higher than those in the light emitting apparatus B. Therefore, it could be confirmed that the luminous efficiency in the second embodiment of the present invention was improved.

### (4) Third Embodiment

A light emitting apparatus according to a third embodiment has the same configuration as that of the above-mentioned light emitting apparatus according to the first embodiment except for a state where a container 4A is filled with a resin.

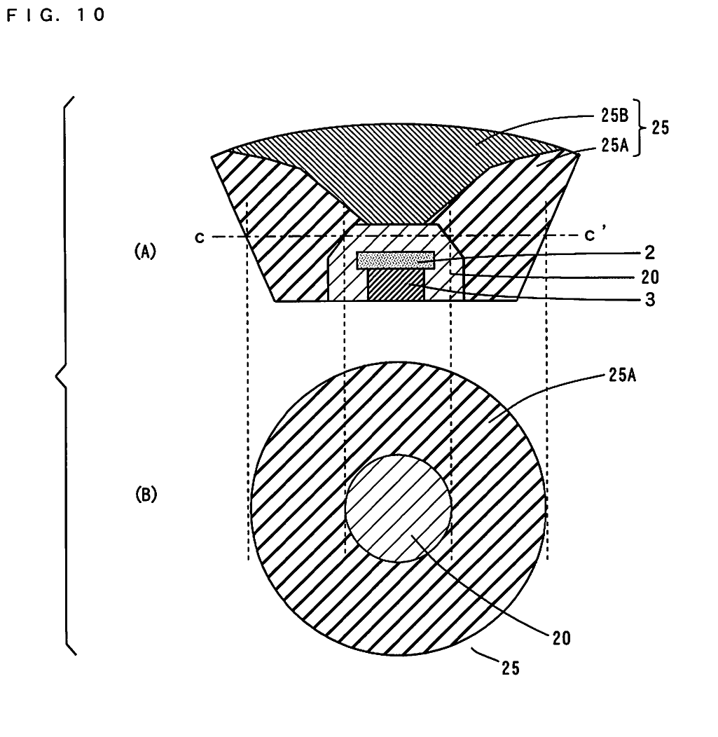

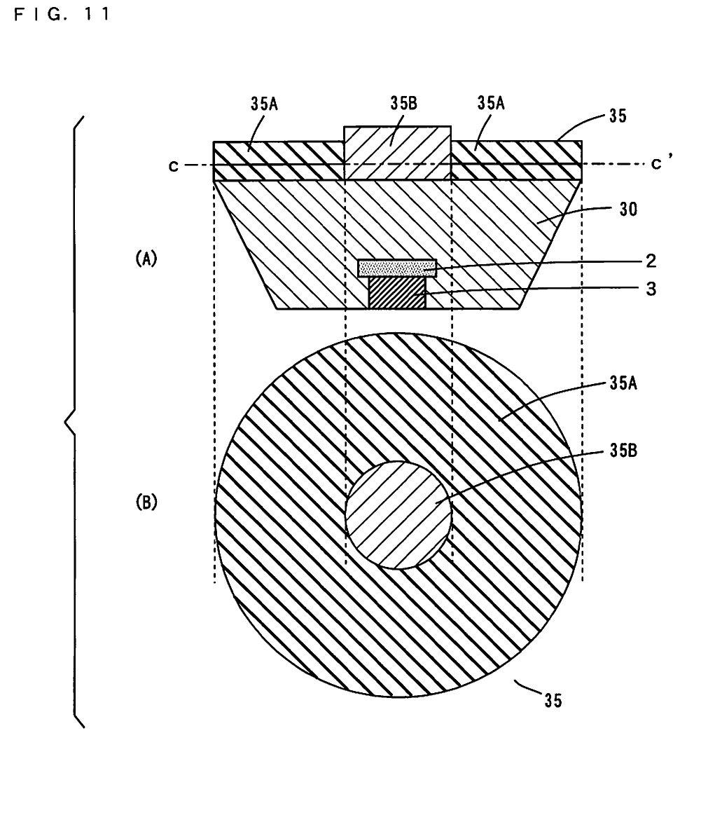

FIG. 10 is a diagram showing a state where the container 4A in the light emitting apparatus according to the third embodiment is filled with a fluorescent substance containing resin 25 or the like, where FIG. 10(A) is a longitudinal sectional view, and FIG. 10(B) is a transverse sectional view taken along a one-dot and dash line c-c′ of FIG. 10(A). In FIG. 10, the same parts as those in the first embodiment are respectively assigned the same reference numerals.

In the light emitting apparatus according to the third embodiment, a fluorescent substance non-containing resin 20 containing no fluorescent substance fills the container 4A so as to completely cover a light emitting device 2 and a spacer 3, as shown in FIG. 10.

The fluorescent substance containing resin 25 that fills the container 4A includes a first fluorescent element 25A and a second fluorescent element 25B. The first fluorescent element 25A contains a blue light emitting fluorescent material (first fluorescent material) composed of a Eu containing oxide. The second fluorescent element 25B contains a green light emitting fluorescent material (second fluorescent material) composed of a Cu containing sulfide and a red light emitting fluorescent material (second fluorescent material) composed of a sulfate oxide.

The first fluorescent element 25A thickly fills the container 4A throughout the periphery on an upper surface of the fluorescent substance non-containing resin 20. The second fluorescent element 25B fills the container 4A so as to cover the center on the upper surface of the fluorescent substance non-containing resin 20 and the top of the first fluorescent element 25A.

Thus, the second fluorescent element 25B is thin throughout the periphery of the container 4A thickly filled with the first fluorescent element 25A, while being thick at the center of the container 4A thinly filled with the first fluorescent element 25A.

In such a configuration, the fluorescent substance non-containing resin 20 fills the container 4A in proximity to the light emitting device 2, so that no fluorescent substance is arranged therein. In a region where the luminous intensity of light emitted from the light emitting device 2 is high, excluding the proximity of the light emitting device 2, that is, a region in a direction inclined at approximately 30 degrees to 60 degrees from a direction perpendicular to a surface on which the light emitting device 2 is mounted, the first fluorescent element 25A and the second fluorescent element 25B are respectively formed in large amounts and small amounts over the entire circumference thereof. On the other hand, in a region where the luminous intensity of the light emitted from the light emitting device 2 is low, excluding the proximity of the light emitting device 2, that is, a region in the direction perpendicular to the surface on which the light emitting device 2 is mounted and its surrounding directions (a region in a direction inclined at zero degree to 30 degrees from the direction perpendicular to the mounting surface), the first fluorescent portion 25A and the second fluorescent portion 25B are respectively formed in small amounts and large amounts. Further, in the region where the luminous intensity of the light emitted from the light emitting device 2 is high, the second fluorescent element 25B does not exist between the light emitting device 2 and the first fluorescent element 25A.

In the present embodiment, the container 4A is filled with the fluorescent substance non-containing resin 20 and the fluorescent substance containing resin 25 in the following manner.

The blue light emitting fluorescent material is mixed into a silicon resin at a ratio of 12% by weight, and is sufficiently diffused, to produce a first fluorescent material containing resin. A mixture of the green light emitting fluorescent material and the red light emitting fluorescent material (e.g., a mixture ratio of 2:5 in weight) is mixed into the silicon resin at a ratio of 28% by weight, and is diffused, to produce a second fluorescent material containing resin.

First, the spacer 3 and the light emitting device 2 are mounted in the container 4A, and a wire 7 is connected to the light emitting device 2. Then, a resin containing no fluorescent substance (e.g., a silicon resin) is applied to the inside of the container 4A so as to have such a thickness as to completely cover the light emitting device 2 and the spacer 3, as shown in FIG. 10, followed by heating for one hour at a temperature of 150° C., to cure the resin.

Then, the first fluorescent material containing resin is applied to the inside of the container 4A so as to have a thickness similar to that of the first fluorescent element 25A shown in FIG. 10, followed by heating for one hour at a temperature of 150° C., to cure the resin.

Furthermore, the second fluorescent material containing resin is applied to the inside of the container 4A so as to have a thickness similar to that of the second fluorescent element 25B, followed by heating for one hour at a temperature of 150° C., to cure the resin.

Thus, the container 4A is filled with the fluorescent substance non-containing resin 20, the first fluorescent element 25A, and the second fluorescent element 25B in the above-mentioned thickness distribution.

In the light emitting apparatus according to the third embodiment of the present invention, the first fluorescent element 25A that is excited to emit a blue light beam is arranged in the region where the luminous intensity of the ultraviolet light emitted from the light emitting device 2 is high, and the second fluorescent element 25B that is excited to emit a green light beam and a red light beam is arranged in the region where the luminous intensity of the ultraviolet light emitted from the light emitting device 2 is low, as in the above-mentioned first embodiment. Therefore, much of the light emitted from the light emitting device 2 is efficiently wavelength-converted into the blue light beam in the first fluorescent element 25A, and some of the blue light beam obtained by the wavelength-conversion is efficiently wavelength-converted into the green light beam and the red light beam in the second fluorescent element 25B. Thus, white light is emitted outward.

Generally, strength and weakness of the light from the light emitting device 2 are unstable because they are affected by an electric field distribution or the like within the light emitting device 2 in proximity to the light emitting device 2. Therefore, the light emitting device 2 has luminous intensity distribution properties that are locally peculiar. In the light emitting apparatus according to the third embodiment, however, the fluorescent substance non-containing resin 20 containing no fluorescent substance is arranged in proximity to the light emitting device 2, which can prevent the above-mentioned problem due to the instability of the strength and weakness of the light in proximity to the light emitting device 2.

Although in the present embodiment, the silicon resin containing no fluorescent substance is arranged in proximity to the light emitting device 2, the present invention is not limited to the silicon resin. Another resin containing no fluorescent substance, e.g., an epoxy-based resin or another silicon-based resin may be arranged. Further, a region containing no fluorescent material other than a resin may be provided in proximity to the light emitting device 2. A region such as a gas, liquid, or vacuum region may be provided in proximity to the light emitting device 2.

### (5) Fourth Embodiment

A light emitting apparatus according to a fourth embodiment has the same configuration as those of the light emitting apparatuses according to the first and third embodiments except for a state where a resin is arranged in a container 4A.

FIG. 11 is a diagram showing a state where a resin is arranged in the container 4A in the light emitting apparatus according to the fourth embodiment, where FIG. 11(A) is a longitudinal sectional view, and FIG. 11(B) is a transverse sectional view taken along a one-dot and dash line c-c′ of FIG. 11(A). In FIG. 11, the same parts as those in the first and third embodiments are respectively assigned the same reference numerals.

In the light emitting apparatus according to the fourth embodiment, a fluorescent substance non-containing resin 30 fills almost the whole of the container 4A so as to completely cover a light emitting device 2 and a spacer 3, as shown in FIG. 11. An upper surface of the fluorescent substance non-containing resin 30 is flat in a direction parallel to a surface on which the light emitting device 2 is mounted.

A florescent substance containing resin 35 arranged in the container 4A includes a first fluorescent element 35A and a second fluorescent element 35B. The first fluorescent element 35A is a ring-shaped sheet containing a blue light emitting fluorescent material (first fluorescent material) composed of a Eu containing oxide and having a hollow portion. The second fluorescent element 35B is a disk-shaped sheet containing a green light emitting fluorescent material (second fluorescent material) composed of a Cu containing sulfide and a red light emitting fluorescent material (second fluorescent material) composed of a sulfate oxide.

The first fluorescent element 35A is arranged on the periphery on a flat upper surface of the fluorescent substance containing resin 30. The second fluorescent element 35B is arranged in a region, of the follow portion of the first fluorescent element 35A, on the flat upper surface of the fluorescent substance containing resin 30.

In such a configuration, the fluorescent substance non-containing resin 30 fills the container 4A in proximity to the light emitting device 2, so that no fluorescent substance is arranged therein. In a region where the luminous intensity of light emitted from the light emitting device 2 is high, excluding the proximity of the light emitting device 2, that is, a region in a direction inclined at approximately 30 degrees to 60 degrees from a direction perpendicular to a surface on which the light emitting device 2 is mounted, the first fluorescent element 35A is arranged over the entire circumference thereof. On the other hand, in a region where the luminous intensity of the light emitted from the light emitting device 2 is low, excluding the proximity of the light emitting device 2, that is, a region in the direction perpendicular to the surface on which the light emitting device 2 is mounted and its surrounding directions (a region in a direction inclined at approximately zero degree to 30 degrees from the direction perpendicular to the mounting surface), the second fluorescent portion 35B is arranged.

In the present embodiment, a resin is formed in the container 4A in the following manner.

The blue light emitting fluorescent material is mixed into a silicon resin, and is sufficiently diffused, to produce a first fluorescent material containing resin. The first fluorescent material containing resin is cured, to produce the ring-shaped sheet having the hollow portion. A mixture of the green light emitting fluorescent material and the red light emitting fluorescent material (e.g., a mixture ratio of 2:5 in weight) is mixed into the silicon resin, and is diffused, to produce a second fluorescent material containing resin. The second fluorescent material containing resin is cured, to produce the disk-shaped sheet.

First, the spacer 3 and the light emitting device 2 are mounted in the container 4A, and a wire 7 is connected to the light emitting device 2. Thereafter, a silicon resin containing no fluorescent substance is applied to the inside of the container 4A such that its surface becomes flat by completely covering the light emitting device 2 and the spacer 3, as shown in FIG. 11, followed by heating for one hour at a temperature of 150° C., to cure the resin.

Then, the ring-shaped sheet having the hollow portion composed of the first fluorescent material containing resin and the disk-shaped sheet composed of the second fluorescent material containing resin are mounted on the silicon resin.

Thus, in the container 4A, the first fluorescent element 35A is arranged on the periphery of an upper surface of the silicon resin containing no fluorescent substance, and the second fluorescent element 35B is arranged at the center thereof.

In the light emitting apparatus according to the fourth embodiment of the present invention, the first fluorescent element 35A that is excited to emit a blue light beam is arranged in the region where the luminous intensity of the ultraviolet light emitted from the light emitting device 2 is high, and the second fluorescent element 35B that is excited to emit a green light beam and a red light beam is arranged in the region where the luminous intensity of the ultraviolet light emitted from the light emitting device 2 is low. Therefore, much of the light emitted from the light emitting device 2 is efficiently wavelength-converted into the blue light beam in the first fluorescent element 35A, and some of the blue light beam obtained by the wavelength-conversion is efficiently wavelength-converted into the green light beam and the red light beam in the second fluorescent element 35B. Thus, white light is emitted outward.

The silicon resin containing no fluorescent substance is arranged in proximity to the light emitting device 2. This can prevent the light emission by the excitation in a region where luminous intensity distribution properties locally differs due to instability of the power of the emitted light in proximity to the light emitting device 2.

Furthermore, in the fourth embodiment, the first fluorescent element 35A and the second fluorescent element 35B are formed by arranging a sheet on a flat upper surface of the silicon resin containing no fluorescent substance. Therefore, the respective thicknesses of the first fluorescent element 35A and the second fluorescent element 35B can be easily adjusted by adding a sheet, changing the thickness of the sheet, or changing the number of sheets, so that a desired luminescent color can be easily realized. Further, the luminescent color can be also adjusted by changing the concentration of the fluorescent material when the sheet is produced.

Although in the present embodiment, the silicon resin serving as a fluorescent substance containing resin is arranged in the region containing no fluorescent material, the present invention is not limited to the silicon resin. Another resin containing no fluorescent substance, e.g., an epoxy-based resin or another silicon-based resin may be arranged. Alternatively, a region such as a gas, liquid, or vacuum region containing no fluorescent material may be provided.

Although in the light emitting apparatus according to the present embodiment, the fluorescent substance containing resin 35 is formed in a sheet shape suitable for the luminous intensity distribution properties of the light emitting device 2 in the first embodiment, a light emitting device having any luminous intensity distribution properties may be used, in which case a fluorescent substance containing resin can be formed in a sheet shape suitable for the luminous intensity distribution properties of the light emitting device.

Although in the present embodiment, both the fluorescent element 35A and the second fluorescent element 35B are composed of the sheet, either one of them may be composed of the sheet.

### (6) Another modification

Although in the first to third embodiments of the present invention, in filling the container 4A with the resin, the resin is cured for each coating, a plurality of resins may be temporarily cured.

Although in the first embodiment of the present invention, the first fluorescent material containing resin is thinly arranged on a surface immediately above the light emitting device 2, the second fluorescent material containing resin may be arranged on the surface immediately above the light emitting device 2.

Although in the first to fourth embodiments of the present invention, the fluorescent substance containing resin is produced by mixing the fluorescent material into the silicon resin, the present invention is not limited to the same. For example, the fluorescent substance containing resin may be produced by mixing a fluorescent material into an epoxy-based resin or another silicon-based resin in place of the silicon resin.

Although in the first to fourth embodiments of the present invention, the blue light emitting fluorescent material is used as the first fluorescent material, and the green light emitting fluorescent material and the red light emitting fluorescent material are used as the second fluorescent material, the present invention is not limited to the same. For example, the blue light emitting fluorescent material and the green light emitting fluorescent material may be used as the first fluorescent material, and the red light emitting fluorescent material may be used as the second fluorescent material.

Although in the first to fourth embodiments of the present invention, the fluorescent substance containing resin is separately arranged in the two fluorescent elements, the fluorescent element containing resin may be separately arranged in three or more fluorescent elements. For example, a first fluorescent element containing a blue light emitting fluorescent material in large amounts is arranged in a region where the power of light emitted from the light emitting device is high, a second fluorescent element containing a red light emitting fluorescent material in large amounts is arranged in a region where the power of the emitted light is high, and a third fluorescent element containing a green light emitting fluorescent material in large amounts may be arranged in a region where the power of the emitted light is intermediate therebetween.

Furthermore, the present invention is also applicable to a configuration in which a plurality of light emitting devices are arranged inside one container.

### (7) Fifth Embodiment

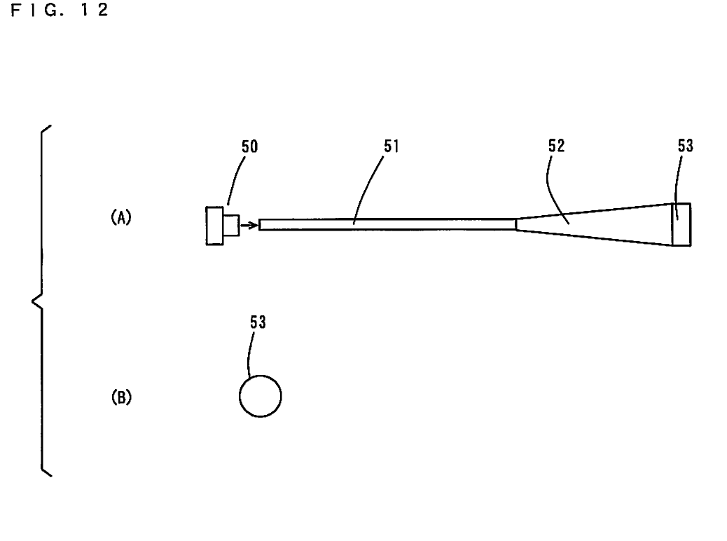

FIG. 12 is a diagram schematically showing the configuration of a light emitting apparatus according to a fifth embodiment of the present invention, where FIG. 12(A) is a side view, and FIG. 12(B) is a front view.

The light emitting apparatus according to the fifth embodiment includes an optical fiber 51, a light diffuser 52 in a substantially conical shape, and a fluorescent substance containing resin 53 in a disk shape. The light diffuser 52 has a facet on the small-diameter side (hereinafter referred to as an incidence facet) and a facet on the large-diameter side (hereinafter referred to as an emission facet). In the light diffuser 52, the diameter thereof linearly increases from the incidence facet to the emission facet. An end of the optical fiber 51 is attached to the incidence facet of the light diffuser 52, and the fluorescent substance containing resin 53 is attached to the emission facet of the light diffuser 52.

The optical fiber 51 has a core and a clad, and introduces laser light emitted from a semiconductor laser device 50 into the light diffuser 52. The diameter of the core is 11 μm, for example, and the diameter of the clad is 125 μm, for example. In the present embodiment, the semiconductor laser device 50 emits near ultraviolet laser light with a wavelength of approximately 420 nm.

The light diffuser 52 is formed of a resin passing the near ultraviolet laser light with a wavelength of approximately 420 nm and reflecting visible light with a longer wavelength than 420 nm. The length of the light diffuser 52 is approximately 6 mm, for example, and the diameter of the emission facet is approximately 1 mm, for example.

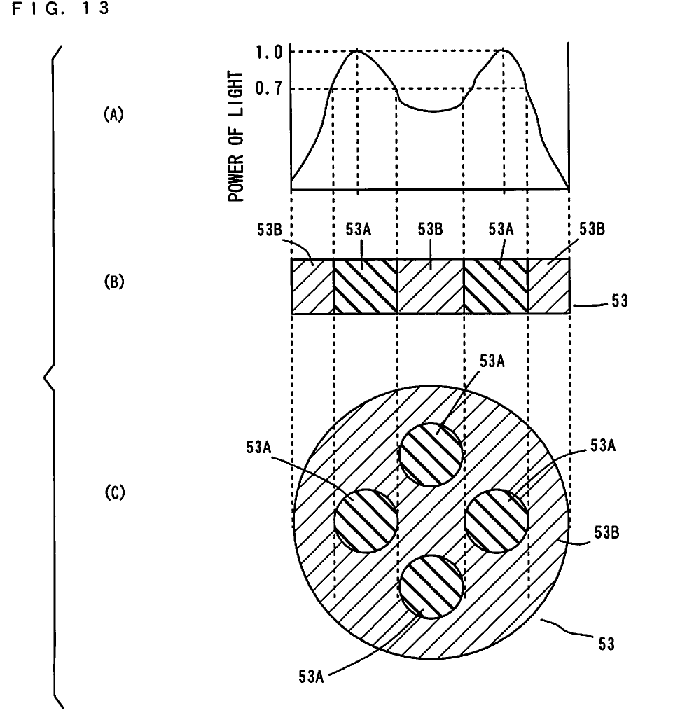

Here, the power of the light at the emission facet of the light diffuser 52 in the light emitting apparatus was measured. FIG. 13(A) is a diagram showing the results of the measurement of the power of the light at the emission facet of the light diffuser 52 in the fifth embodiment, FIG. 13(B) is a cross-sectional view of the fluorescent substance containing resin 53 in the fifth embodiment, and FIG. 13(C) is a plan view of the fluorescent substance containing resin 53 in the fifth embodiment.

As can be seen from the results of the measurement in FIG. 13(A), the power of the light from the semiconductor laser device 50 is low at the center and on the periphery of the emission facet, while taking a maximal value in an annular region between the center and the periphery.

In the light emitting apparatus according to the fifth embodiment, the fluorescent substance containing resin 53 includes a first fluorescent element 53A and a second fluorescent element 53B. The first fluorescent element 53A is a disk-shaped sheet containing a blue light emitting fluorescent material (first fluorescent material) excited by the laser light with a wavelength of approximately 420 nm. The blue light emitting fluorescent material is the same as the blue light emitting fluorescent materials in the first to fourth embodiments.

The second fluorescent element 53B is a disk-shaped sheet containing a green light emitting fluorescent material (second fluorescent material) and a red light emitting fluorescent material (second fluorescent material) and having four circular holes in the annular region between the center and the periphery. The first fluorescent element 53A is arranged in each of the four holes of the second fluorescent element 53B. The green light emitting fluorescent material and the red light emitting fluorescent material are the same as the green light emitting fluorescent materials and the red light emitting fluorescent materials in the first to fourth embodiments.

In the present embodiment, the fluorescent substance containing resin 53 is formed in the following manner.

Four first fluorescent elements 53A in a disk shape and one second fluorescent element 53B in a disk shape are produced. The diameter of the first fluorescent element 53A is smaller than the diameter of the second fluorescent element 53B. The four holes are equally spaced in the annular region between the center and the periphery of the second fluorescent element 53B. The diameter of the hole is equal to the diameter of the first fluorescent element 53A. The first fluorescent elements 53A are respectively fitted in the holes of the second fluorescent element 53B, to produce the fluorescent substance containing resin 53. Thereafter, the fluorescent substance containing resin 53 adheres to the emission facet of the light diffuser 52.

In the light emitting apparatus according to the fifth embodiment of the present invention, the first fluorescent element 53A that is excited to emit a blue light beam is arranged in a region where the power of the near ultraviolet laser light emitted from the light emitting device 50 is high, and the second fluorescent element 53B that is excited to emit a green light beam and a red light beam is arranged in a region where the power of the emitted near ultraviolet laser light is low. Therefore, much of the laser light is efficiently wavelength-converted into the blue light beam in the first fluorescent element 53A, and some of the blue light beam obtained by the wavelength-conversion is efficiently wavelength-converted into the green light beam and the red light beam in the second fluorescent element 53B. Thus, white light is emitted outward.

Also in the light emitting apparatus according to the present embodiment, the luminous efficiency thereof can be improved while maintaining high color rendering properties, as in the light emitting apparatuses in the first to fourth embodiments.

### (8) Other Modifications

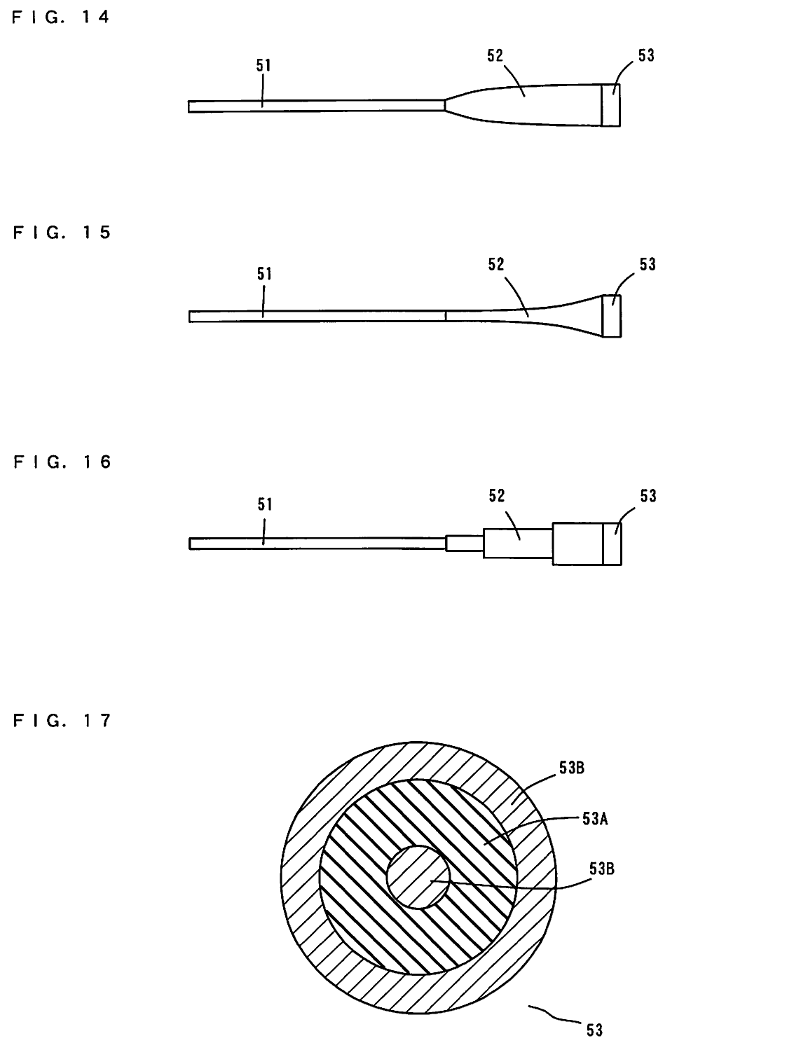

In the fifth embodiment of the present invention, the light diffuser 52 shown in FIG. 12 may be replaced with a light diffuser 52 having another shape. FIGS. 14, 15, and 16 are respective side views schematically showing other examples of the light diffuser 52.

In the light diffuser 52 shown in FIG. 14, the diameter thereof linearly increases from its incidence facet to emission facet, and the rate of increase is high on the side of the incidence facet, while being low on the side of the emission facet. In the light diffuser 52 shown in FIG. 15, the diameter thereof increases in a curved shape from its incidence facet to emission facet, and the rate of increase is low on the side of the incidence facet, while being high on the side of the emission facet. In the light diffuser 52 shown in FIG. 16, the diameter gradually increases from the incidence facet to the emission facet.

Although in the fifth embodiment of the present invention, the first fluorescent elements 53A are respectively arranged in the holes of the second fluorescent element 53B, the present invention is not limited to the same. For example, the first fluorescent elements 53A may be arranged on the second fluorescent element 53B having no holes. In this case, it is preferable that the first fluorescent elements 53A are arranged on a surface, on the side of the emission facet of the light diffuser 52, of the second fluorescent element 53B such that laser light from the emission facet of the light diffuser 52 is directly incident on the first fluorescent elements 53A.

Although in the fifth embodiment of the present invention, the four first fluorescent elements 53A are arranged in the annular region between the center and the periphery of the fluorescent substance containing resin 53, the present invention is not limited to the same. FIG. 17 is a diagram showing another example of the arrangement of the first fluorescent element 53A in the fluorescent substance containing resin 53. In the example shown in FIG. 17, a second fluorescent element 53B in a disk shape is arranged at the center of the fluorescent substance containing resin 53, a second fluorescent element 53B in a ring shape is arranged on the periphery thereof, and a first fluorescent element 53A in a ring shape is arranged between the center and the periphery. In this example, the luminous efficiency of the light emitting apparatus can be also improved while maintaining high color rendering properties, as in the example shown in FIG. 13.

Although in the fifth embodiment of the present invention, the light diffuser 52 does not have an optical element such as a lens, an optical element such as a lens may be provided inside the light diffuser 52 in order to collect or diffuse laser light. In this case, the power of the light at the emission facet of the light diffuser 52 is measured, and the first fluorescent element 53A and the second fluorescent element 53B in the fluorescent substance containing resin 53 are arranged on the basis of the results of the measurement.

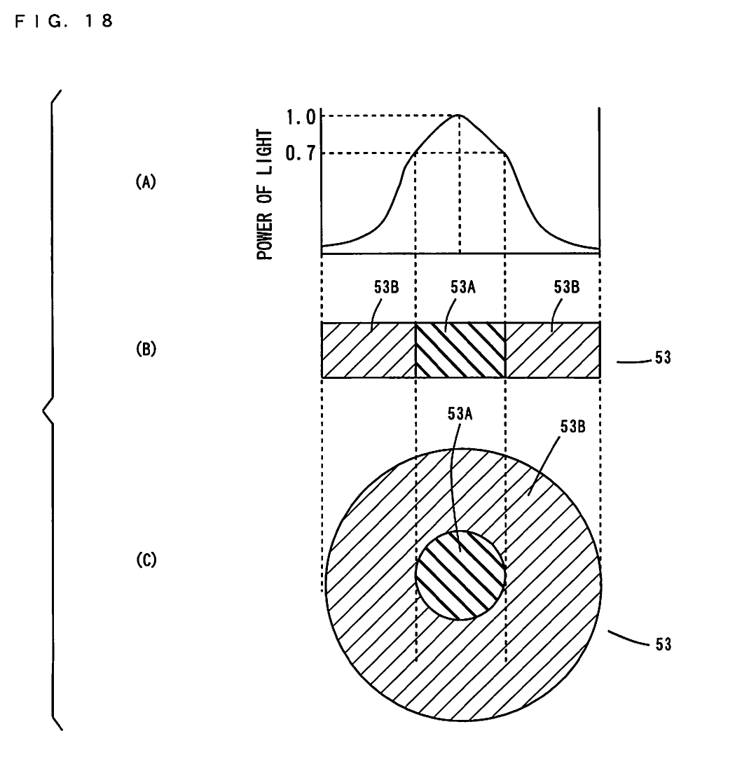

FIG. 18(A) is a diagram showing another example of the light power at the emission facet of the light diffuser 52, FIG. 18(B) is a cross-sectional view showing the arrangement of the fluorescent substance containing resin 53 corresponding to the light power shown in FIG. 18(A), and FIG. 18(C) is a plan view showing the arrangement of the fluorescent substance containing resin 53 corresponding to the light power shown in FIG. 18(A).

The light power shown in FIG. 18(A) takes a maximal value at the center of the emission facet, while being low on the periphery thereof. In this case, the first fluorescent element 53A in a disk shape is arranged at the center of the fluorescent substance containing resin 53, and the second fluorescent element 53B in a ring shape is arranged on the periphery thereof. In this example, the luminous efficiency of the light emitting apparatus can be also improved while maintaining high color rendering properties, as in the example shown in FIG. 13.

Although the light emitting apparatus according to the fifth embodiment of the present invention includes the optical fiber 51, the light emitting apparatus need not have the optical fiber 51. In this case, the laser light emitted from the semiconductor laser device 50 is directly incident on the light diffuser 52, or the laser light emitted from the semiconductor laser device 50 is incident on the light diffuser 52 using another optical system such as a lens.

Although in the light emitting apparatuses according to the first to fourth embodiments, the first fluorescent element contains only the first fluorescent material, and the second fluorescent element contains only the second fluorescent material, each of the first fluorescent element and the second fluorescent element may contain the first and second fluorescent materials, and the ratio of the concentration of the first fluorescent material to the concentration of the second fluorescent material in the first fluorescent element may be made higher than the ratio of the concentration of the first fluorescent material to the concentration of the second fluorescent material in the second fluorescent element, as in the modification of the first embodiment.

### (9) Correspondence between Elements in the Claims and Parts in Preferred Embodiments

In the following paragraphs, non-limiting examples of correspondences between various elements recited in the claims below and those described above with respect to various preferred embodiments of the present invention are explained.

In the preferred embodiments described above, the fluorescent substance containing resins 5, 15, 25, 35, and 53 are examples of a fluorescent substance, the first fluorescent elements 5A, 15A, 25A, 35A and 53A are examples of a first region, the second fluorescent elements 5B, 15B, 25B, 35B and 53B are examples of a second region, the blue light emitting fluorescent material is an example of a first fluorescent material, and the green light emitting fluorescent material and the red light emitting fluorescent material are examples of a second fluorescent material. The frame 4 is an example of a support in the first to fourth embodiments, while the light diffuser 52 is an example of a support in the fifth embodiment. Furthermore, the light emitting devices 2 and 12 are examples of a light emitting device in the first to fourth embodiments, while the semiconductor laser device 50 is an example of a light emitting device in the fifth embodiment.

Furthermore, the first fluorescent element 35A is an example of a first sheet and the second fluorescent element 35B is an example of a second sheet in the fourth embodiment, while the first fluorescent element 53A is an example of a first sheet and the second fluorescent element 53B is an example of a second sheet in the fifth embodiment.

As each of various elements recited in the claims, various other elements having configurations or functions described in the claims can be also used.

While preferred embodiments of the present invention have been described above, it is to be understood that variations and modifications will be apparent to those skilled in the art without departing the scope and spirit of the present invention. The scope of the present invention, therefore, is to be determined solely by the following claims.

What is claimed is:

1. A light emitting apparatus, comprising:
a light emitting device; and
a fluorescent substance that converts light emitted from said light emitting device into light with a longer wavelength than said emitted light,
wherein the fluorescent substance has first and second regions, and contains
a first fluorescent material that is excited to emit a light beam with a first wavelength, and
a second fluorescent material that is excited to emit a light beam with a second wavelength longer than said first wavelength,
the power of said emitted light in a first direction is higher than the power of said emitted light in a second direction,
the volume of said first region in said first direction is larger than the volume of said second region in said first direction, and the volume of said second region in said second direction is larger than the volume of said first region in said second direction, and
the ratio of the concentration of said first fluorescent material to the concentration of said second fluorescent material in said first region is higher than the ratio of the concentration of said first fluorescent material to the concentration of said second fluorescent material in said second region.

2. The light emitting apparatus according to claim 1, wherein
said first fluorescent material includes a fluorescent material that is excited to emit a blue-based light beam.

3. The light emitting apparatus according to claim 1, wherein
said first fluorescent material includes a fluorescent material that is excited to emit a blue-based light beam, and
said second fluorescent material includes a fluorescent material that is excited to emit a green-based light beam and a fluorescent material that is excited to emit a red-based light beam.

4. The light emitting apparatus according to claim 1, wherein
a region containing no fluorescent material is provided between said light emitting device and said fluorescent substance.

5. The light emitting apparatus according to claim 1, wherein
said first region is composed of a first sheet including said first fluorescent material, and
said second region is composed of a second sheet including said second fluorescent material.

6. The light emitting apparatus according to claim 1, wherein
said emitted light is ultraviolet light.

7. The light emitting apparatus according to claim 1, wherein
said first and second regions are concentrically arranged.

8. The light emitting apparatus according to claim 1, wherein
said light emitting device is a light emitting diode.

9. The light emitting apparatus according to claim 1, wherein
said light emitting device is a semiconductor laser device.

10. The light emitting apparatus according to claim 1, further comprising
a support that supports said fluorescent substance such that the emitted light from said light emitting device is incident on said fluorescent substance.
